(19) United States
(12) Patent Application Publication
(10) Pub. No.: US 2025/0219328 A1
(43) Pub. Date: Jul. 3, 2025

(54) Secured Plug-in Smart Device

(71) Applicant: Jasco Products Company, LLC, Oklahoma City, OK (US)

(72) Inventors: Mark Simpkins, Oklahoma City, OK (US); Matt Henson, Oklahoma City, OK (US)

(73) Assignee: Jasco Products Company, PLLC, Oklahoma City, OK (US)

(21) Appl. No.: 18/401,244

(22) Filed: Dec. 29, 2023

(51) Int. Cl. H01R 13/639

(52) U.S. Cl. CPC H01R 13/6395

(57) ABSTRACT

The present invention relates in general to plug-in electrical devices, and in particular to plug-in electrical devices which may be mounted to an outlet to create a more secure attachment of the device. The invention comprises a plug-in electrical device containing a retractable wall-mount that secures the device to an outlet. The invention also provides a user an option to plug-in the electrical device while having the mount in a full closed position, whereas the mount is retracted and not in use. Embodiments described for the present invention comprise an electrical device, an electrical plug, a retractable mount, whereas the mount secures to an outlet. The mount is comprised of an aperture configured to allow the passage of a body of a wall mounting screw, and the mount is configured to be secured to the outlet by a head of the wall mounting screw.

### BACKGROUND OF THE INVENTION

### 1. Field of the Invention

The present invention relates in general to plug-in electrical devices, and in particular to plug-in electrical devices which may be mounted to an outlet to create a more secure attachment of the device.

### 2. Description of the Related Art

Plug-in electrical devices, typically, are comprised of a plug which extends out from an electrical device housing. The device may be plugged-in and easily removed. However, situations and applications exist where a user may want an electrical device to be more securely attached to an outlet. Examples of such applications include the placement of an electrical device for the benefit of a multi-unit residential community or a commercial property. Here, a property manager or manager might prefer that the device be secure, thus not easily removed by a tenant or customer.

Surge protectors and outlet extenders which mount to an outlet through a receptacle mounting screw are known in the prior art. The devices cover both receptacles in a dual receptacle outlet, and are attached with the mounting screw through a middle of the device housing.

Surge protectors, outlet extenders, and smart plugs which plug into a single receptacle of a dual outlet are known in the prior art. These devices are not securely attached to an outlet, and do not contain a mount, a retractable mount, or an attachment of the device to an outlet by means of a wall mounting screw.

### SUMMARY OF THE INVENTION

The present invention comprises a plug-in electrical device containing a retractable wall-mount that secures the device to an outlet. The invention also provides a user an option to plug-in the electrical device while having the mount in a full closed position, whereas the mount is retracted and not in use.

Embodiments described for the present invention comprise an electrical device, an electrical plug, a retractable mount, whereas the mount secures to an outlet. The mount is comprised of an aperture configured to allow the passage of a body of a wall mounting screw, and the mount is configured to be secured to the outlet by a head of the wall mounting screw.

One embodiment comprises a housing of the electrical device, a mount tab, and at least one mount rib. The housing of the electrical device is comprised of a slot configured to accommodate the mount tab, whereas the at least one mount rib is configured to lock the mount into a full closed position, or a full open position.

Other embodiments may comprise a smart plug-in electrical device, and/or a plug-in electrical device configured to plug-in to one receptacle of a dual-receptacle outlet, whereas the plug-in electrical device is configured to utilize only one receptacle in a dual-receptacle outlet, and the plug-in electrical device is configured to allow access of a second receptacle in the dual-receptacle outlet.

It should be appreciated that combinations of the foregoing concepts and additional concepts discussed in greater detail below are contemplated as being part of the inventive subject matter disclosed herein. In particular, all combinations of claimed subject matter appearing at the end of this disclosure, or elsewhere herein, are contemplated as being part of the inventive subject matter.

These and other systems, methods, objects, features, and advantages of the present invention will be apparent to those skilled in the art from the following detailed description of the preferred embodiment and the drawings.

### BRIEF DESCRIPTION OF THE DRAWINGS

One or more embodiments are illustrated by way of example, and not by limitation, reference will now be made to the accompanying drawings, having the same numeral designations to represent like elements throughout and wherein:

FIG. 1 shows a front elevational view of an embodiment of a device;

FIG. 2 shows another front elevational view of the embodiment of a device;

FIG. 3 shows a rear elevational view of an embodiment of a device;

FIG. 4 shows a rear elevational view of an embodiment of a device;

FIG. 5 shows a top plan view of an embodiment of a device;

FIG. 6 shows a rear sectional view of an embodiment of a device, where a mount is completely separated from a housing for illustration purposes;

FIG. 7 shows a rear sectional view of an embodiment of a device; and

FIG. 8 shows a rear sectional view of an embodiment of a device.

While the invention has been described in connection with certain preferred embodiments, other embodiments would be understood by one of ordinary skill in the art and are encompassed herein.

Elements with corresponding reference numerals:

| | |
|---|---|
| Electrical outlet device | 100 |
| Housing | 2 |
| Power button | 4 |
| Mount | 8 |
| Mount aperture | 10 |
| Plug | 12 |
| Rear side of device | 14 |
| Housing support structures | 16 |
| Mount ribs | 18 |
| Housing slot | 20 |
| Mount track | 22 |
| Receptacle | 24 |
| Mount track enlarged area | 26 |
| Power outlet housing | 28 |
| Mount tab | 30 |

### DETAIL DESCRIPTION OF THE INVENTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in order to facilitate describing the subject innovation. Moreover, it is to be appreciated that the drawings may not be to scale.

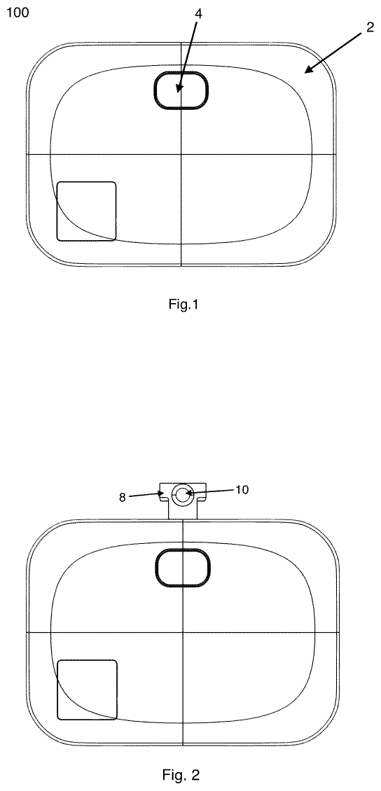

FIG. 1 shows a front elevational view of an embodiment of a device. In this embodiment, a smart plug-in electrical device 100 is shown. A power button 4 may be visible from the front side of the housing 2. Many variations and modifications of the electrical device will become apparent to those skilled in the art. Alternate embodiments may be devised without departing from the spirit or scope of the invention.

FIG. 2 shows another front elevational view of the embodiment of a device. In this view, a mount 8 is extended to a full open position. The mount 8 may be retractable. The mount 8 secures to an outlet (not shown). The mount is comprised of an aperture 10 configured to allow the passage of a body of a wall mounting screw, and the mount 10 is configured to be secured to the outlet by a head of the wall mounting screw.

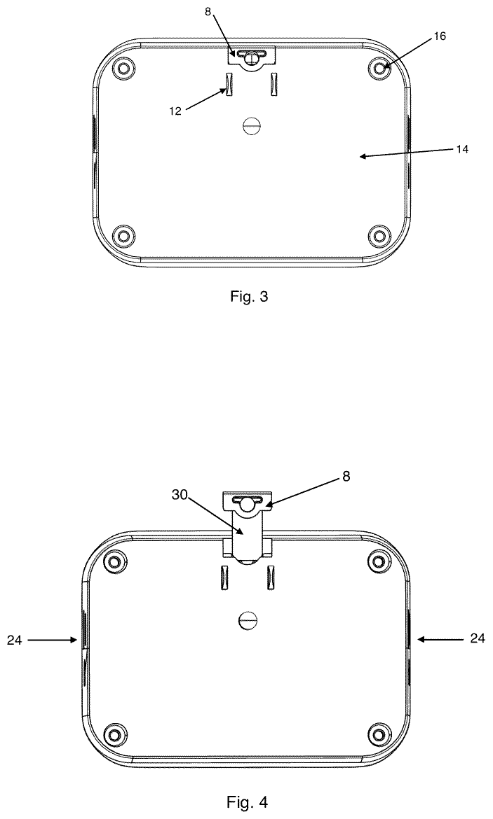

FIG. 3 shows a rear elevational view of the embodiment of a device. An electrical plug 12 extends out from the rear side of the device 14. Housing support structures 16 may be located near corners of the device. In this illustration, the retractable mount 8 is in a full closed position. A mount tab (not shown) is fully inserted within the housing of the electrical device. In the full closed position, the mount is not utilized, and the device may be easily removed from an outlet.

FIG. 4 shows a rear elevational view of an embodiment of a device. In this illustration, the retractable mount 8 is in a full open position. The mount tab 30 is extended from the device housing 2. In this embodiment, the device is comprised of two receptacles 24. The device may be comprised of various elements of power supply, including, but not limited to: two-prong electrical outlets, three-prong electrical outlets, USB, and a USB-combination. In this embodiment, the mount tab 30 is a continuous piece with the mount 8, the mount tab 30 is a part of the mount 8.

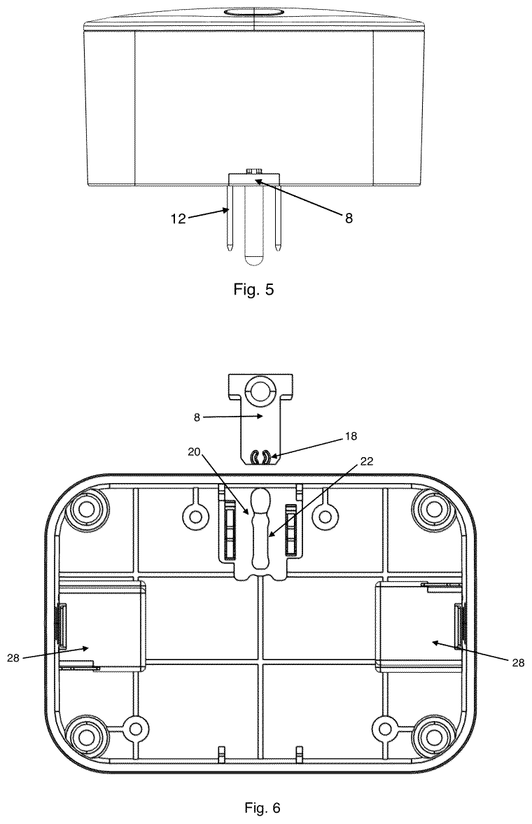

FIG. 5 shows a top plan view of an embodiment of a device. The top of the mount 8 and the extension of the plug from the housing are illustrated. The height, depth, and width of the device may vary.

FIG. 6 shows a rear sectional view of an embodiment of a device, where a mount is completely separated from a housing for illustration purposes. Mount ribs 18 may extend from the mount tab area of the mount 8. The housing of the electrical device is comprised of a housing slot 20 configured to accommodate the mount tab. A mount track 22 is configured to accommodate at least one mount rib 18. The at least one mount rib locks the mount into a full closed or a full open position. In this embodiment, two separate power outlet housings 28 provide structure for two separate outlets.

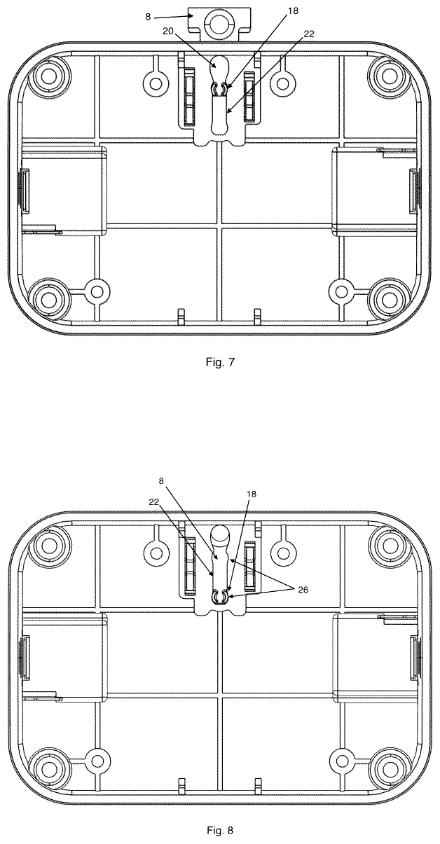

FIG. 7 shows a rear sectional view of an embodiment of a device in the full open position. The mount 8 is extended away from the housing, allowing the device to be securely mounted to an outlet. The aperture within the mount accommodates the passage of a body of a wall mounting screw, and the mount is configured to be secured to the outlet by a head of the wall mounting screw. Mount ribs 18 extend through a mount track 22 of the housing slot 20. The mount, slot, and other elements of the device may be comprised of varying materials. Embodiments may include a plastic mount, slot, and other elements, or embodiments may include a metal, or other, mount, slot, and elements.

FIG. 8 shows a rear sectional view of an embodiment of a device in a full closed position. The mount 8 is retracted within the housing, allowing the device to be easily removed from an outlet. In this embodiment, the mount track is comprised of a linear opening/track with two areas 26 that enlarge the opening/track, configured to allow the mount ribs to lock the mount into a full open position at one of the two areas, and lock into a full closed position at another one of the two areas. The mount ribs may be held under tension while moving along the mount track, and each of the two enlarged areas along the track are configured to allow the ribs to release tension and lock into place.

Embodiments may comprise a smart plug-in electrical device, and/or a plug-in electrical device configured to plug-in to one receptacle of a dual-receptacle outlet, whereas the plug-in electrical device is configured to utilize only one receptacle in a dual-receptacle outlet, and the plug-in electrical device is configured to allow access of a second receptacle in the dual-receptacle outlet.

Alternate embodiments may comprise a mount that is stationary, not retractable. The mount is comprised of an aperture configured to allow the passage of a body of a wall mounting screw, and the mount is configured to be secured to the outlet by a head of the wall mounting screw.

Although the present invention has been described in relation to particular embodiments thereof, many other variations and modifications will become apparent to those skilled in the art. It is preferred, therefore, that the present invention be limited not by the specific disclosure herein, but only by the appended claims. Alternate embodiments may be devised without departing from the spirit or scope of the invention. Further, the particular feature or structure may be combined in any suitable manner in one or more embodiments.

What is claimed is:

1. A plug-in electrical device, comprising:
an electrical device;
an electrical plug;
a mount, whereas the mount secures to an outlet;
the mount is retractable; and
the mount is comprised of an aperture configured to allow the passage of a body of a wall mounting screw, and the mount is configured to be secured to the outlet by a head of the wall mounting screw.

2. The plug-in electrical device of claim 1, further comprising:
a housing of the electoral device;
a mount tab;
at least one mount rib;
the housing of the electrical device comprised of a slot configured to accommodate the mount tab; and
whereas the at least one mount rib configured to lock the mount into a full closed position, or a full open position.

3. The plug-in electrical device of claim 1, further comprising:
a smart plug-in device.

4. The plug-in electrical device of claim 1, further comprising:
the plug-in electrical device configured to plug-in to one receptacle of a dual-receptacle outlet, whereas the plug-in electrical device is configured to utilize only one receptacle in a dual-receptacle outlet; and
the plug-in electrical device configured to allow access of a second receptacle in the dual-receptacle outlet.

5. The plug-in electrical device of claim 1, further comprising:
a housing of the electrical device;
a mount tab;
the mount tab is configured to lock into a full closed position or a full open position;
the housing of the electrical device comprised of a slot configured to accommodate the mount tab; and
whereas the mount tab is configured to be fully enclosed within the housing of the electrical device in the full closed position, and a top of the mount is configured to be level with a top of the housing of the electrical device in the full closed position.

6. A plug-in electrical device, comprising:
an electrical device;
an electrical plug;
a mount, whereas the mount secures to an outlet;
the mount is retractable;
the mount is comprised of an aperture configured to allow the passage of a body of a wall mounting screw, and the mount is configured to be secured to the outlet by a head of the wall mounting screw;
a housing of the electoral device;
a mount tab;
at least one mount rib;
the housing of the electrical device comprised of a slot configured to accommodate the mount tab; and
whereas the at least one mount rib configured to lock the mount into a full closed position, or a full open position.

7. The plug-in electrical device of claim 6, further comprising:
a smart plug-in electrical device.

8. The plug-in electrical device of claim 6, further comprising:
the plug-in electrical device configured to plug-in to one receptacle of a dual-receptacle outlet, whereas the plug-in electrical device is configured to utilize only one receptacle in a dual-receptacle outlet; and
the plug-in electrical device configured to allow access of a second receptacle in the dual-receptacle outlet.

9. The plug-in electrical device of claim 6, further comprising:
a housing of the electrical device;
a mount tab;
the mount tab is configured to lock into a full closed position or a full open position;
the housing of the electrical device comprised of a slot configured to accommodate the mount tab; and
whereas the mount tab is configured to be fully enclosed within the housing of the electrical device in the full closed position, and a top of the mount is configured to be level with a top of the housing of the electrical device in the full closed position.

10. A plug-in electrical device, comprising:
an electrical device;
an electrical plug;
a mount, whereas the mount secures to an outlet; and
the mount is comprised of an aperture configured to allow the passage of a body of a wall mounting screw, and the mount is configured to be secured to the outlet by a head of the wall mounting screw.

11. The plug-in electrical device of claim 10, further comprising:
a smart plug-in device.

12. The plug-in electrical device of claim 10, further comprising:
the plug-in electrical device configured to plug-in to one receptacle of a dual-receptacle outlet, whereas the plug-in electrical device is configured to utilize only one receptacle in a dual-receptacle outlet; and
the plug-in electrical device configured to allow access of a second receptacle in the dual-receptacle outlet.
